(19) United States
(12) Patent Application Publication
(10) Pub. No.: US 2008/0197098 A1
(43) Pub. Date: Aug. 21, 2008

(54) Cap Enabling Reusable Pacifiers And Feeding Bottles To Be Sterilized In A Microwave Oven

(76) Inventor: Alaa Khashoggi, Golfe-Juan (FR)

Correspondence Address: BLANK ROME LLP, 600 NEW HAMPSHIRE AVENUE, N.W., WASHINGTON, DC, 20037, US

(21) Appl. No.: 11/628,461

(22) PCT Filed: Jun. 3, 2005
(86) PCT No.: PCT/FR2005/001367

§ 371 Date: Dec. 10, 2007

(30) Foreign Application Priority Data
Jun. 4, 2004 (FR) 0406079

(51) Int. Cl. A61J 9/08; A61J 17/00

(52) U.S. Cl. 215/11.6; 606/236; 606/234

(57) ABSTRACT

A cap for reusable pacifiers and feeding bottles, where the cap is advantages in that it enables same to be quickly sterilized in a microwave oven. The cap is characterized in that it includes a conventional body suitable for fitting over a nipple holder. A port is provided in the upper cap portion to enable steam to escape. A valve attached to the top of the cap port is characterized in that it has a small ventilated cap housing an upside-down flexible vessel. The cap can be attached either to a feeding bottle or to a pacifier to enable the sterilization in a microwave oven. A feeding bottle or pacifier can be sterilized simply by filling the same with a small amount of water, closing the valve cap and boiling the water in a microwave oven. The water turns into steam and sterilizes the inside of the entire feeding bottle or pacifier and the pressurized steam escapes through the valve.

The present invention relates to a cap for reusable pacifiers and feeding bottles, which have the advantage of being capable of being quickly sterilised in a microwave oven.

Newborn babies are fed through a sterile feeding bottle. The pacifiers used to pacify newborn babies are also sterilised before use. The sterility of the feeding bottle teat, teat-holding ring, inside of the cap and inside of the body of the feeding bottle as well as the sterility of the pacifier teat and teat-holder are imperative so as to avoid any risk of ingesting micro-organisms which are harmful to the newborn baby who has not yet developed his/her immune system.

Feeding bottles and pacifiers are usually sterilised using the following methods:

Sterilisation in boiling water: the feeding bottle assembly is taken apart; the teat, teat-holding ring and cap are placed along with the pacifiers into boiling water. After 15 minutes, the assembly is reassembled in the open air.

Sterilisation in an electric steam steriliser: the feeding bottle assembly is taken apart; the teat, teat-holding ring and cap are placed along with the pacifiers into the steriliser container. The steriliser steams them for 15 minutes. Then, the parts are reassembled in the open air.

Cold sterilisation: the feeding bottle assembly is taken apart; the teat, teat-holding ring and cap are placed along with the pacifiers into a liquid containing a sterilising product (tablets or liquid).

Sterilisation in a steam steriliser designed for a microwave oven: the feeding bottle assembly is taken apart; the teat, teat-holding ring and cap are placed along with the pacifiers into the steriliser container.

The steriliser, filled with water, is then inserted in the microwave. The oven causes the water to boil and steams the parts for a few minutes.

The parts are then reassembled in the open air.

These methods have several disadvantages:

The need to purchase specialised equipment. This equipment is bulky and expensive (the price of several feeding bottles).

The lack of absolute sterility, since the user handles the parts in the open air after sterilisation.

Considerable sterilisation, cooling and assembly times.

The present invention aims to allow microwave-oven sterilisation of a feeding bottle or pacifier and of all their parts in one go, without disassembling or handling sterile parts during reassembly, to save in time and effort when sterilising feeding bottles and pacifiers and to avoid having to purchase specific sterilisation equipment.

The cap is characterised by having:

a standard body (1) which can be affixed in a watertight fashion to a teat-holder, feeding bottle or pacifier or to the body of a feeding bottle.

an orifice (2) in the top part of the cap for evacuating steam.

means of allowing steam through the orifice (2) and then hermetically resealing the orifice after sterilisation. Said means can, in particular, consist of a valve fitted over the cap orifice, characterised by having a small, ventilated cap (3) which houses an inverted flexible bubble (4).

The invention also relates to a reusable pacifier or feeding bottle comprising at least one cap (1) according to the invention.

Said reusable pacifier or feeding bottle according to the invention is advantageously watertight and airtight after sterilisation.

This cap can be used to sterilise either a feeding bottle or a pacifier.

In feeding bottle sterilisation mode, the bottle is characterised by having:

an advantageously graduated body (5) with a threaded opening that is capable of receiving the teat-holder

a teat-holder (6) that is capable of receiving a teat and of screwing into the body of the feeding bottle

a teat (7) that is capable of being inserted into the teat-holder (6)

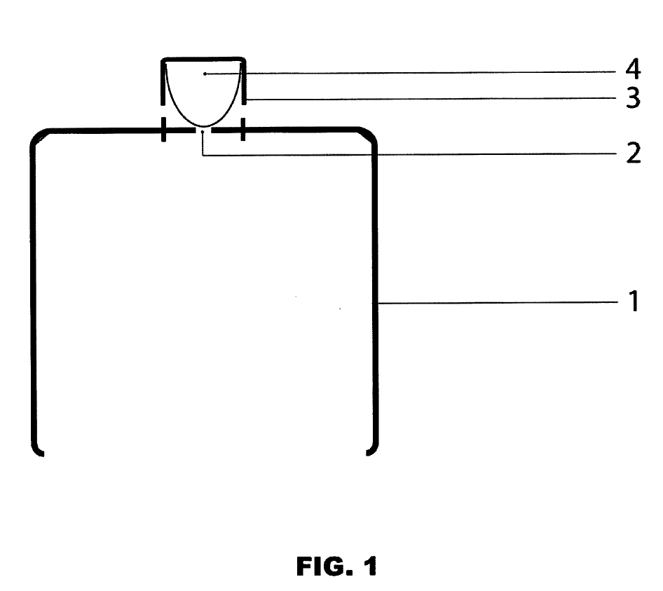

a cap (1) as described above in FIG. 1

In pacifier sterilisation mode, the pacifier is characterised by having:

a teat-holder (9)

a teat (10) that is capable of being inserted into the teat-holder (9)

a ring affixed to the teat-holder (11)

a cap as described above in FIG. 1.

The appended drawings depict the invention and are provided as a strictly non-limiting example.

FIG. 1 shows a cross-section of the cap and the pressure valve.

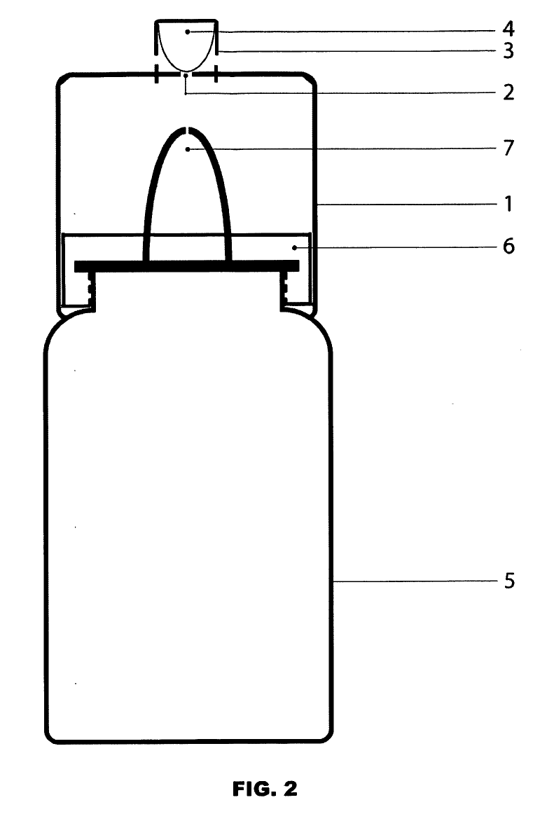

FIG. 2 shows an elevation cross-section of the feeding bottle assembly ready for sterilisation.

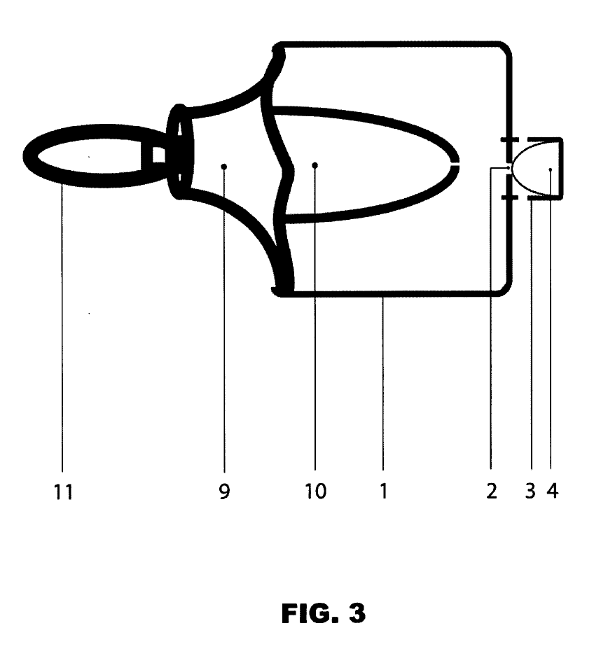

FIG. 3 shows a cross section of the pacifier assembly ready for sterilisation.

### OPERATING MODE

Feeding Bottle Sterilisation.

A small amount of water is inserted in the body (5) of the feeding bottle.

The teat (7) is inserted in the teat-holder (6) and then screwed onto the body of the feeding bottle.

The cap (1) is fitted onto the teat-holder (6).

The feeding bottle assembly is then placed in vertical position in the microwave oven. The latter is switched on at full power for a predetermined amount of time according to the size of the feeding bottle, between one and two minutes.

The microwaves cause the water to boil and evaporate. The steam can then sterilise the inside of the body of the feeding bottle (5). The steam then rises into the teat (7) and sterilises the inside of it, and then exits through the teat orifice to sterilise the outside of the teat and the inside of the cap (1). The air expansion caused by the hot steam causes a build-up of positive pressure inside the feeding bottle assembly. This pressure ensures better penetration of the steam on the surfaces of all the parts of the feeding bottle and disables any micro-organisms that may be found on the surfaces. Once this pressure reaches a considerable level, the steam can escape through the orifice (2) located in the top surface of the cap and push the flexible bubble (4) of the valve (3) so as to escape through the ventilation holes of the latter. In order to prevent any risk of explosion, the cap comes free from the teat-holder in the event of valve failure.

The cap (1) according to the invention can advantageously comprise means for releasing the cap from the teat-holder (6).

Once sterilised, the feeding bottle is ready for use. It is watertight, sterile and can receive milk, water or any other liquid food product. Once the food has been consumed, it can be washed and sterilised again for the next use.

Pacifier Sterilisation.

A small amount of water is inserted in the pacifier cap (1).

The cap (1) is fitted onto the teat-holder (9).

The pacifier assembly is then placed in the microwave oven. The latter is switched on at full power for a predetermined amount of time. The microwaves cause the water to boil and evaporate. The steam can then sterilise the inside of the cap (1) as well as the teat (10) and the teat-holder (9). The air expansion caused by the hot steam causes a build-up of positive pressure inside the cap. This pressure ensures better penetration of the steam on the surfaces of all the parts of the pacifier and disables any micro-organisms that may be found on the surfaces. Once this pressure reaches a certain threshold, the steam can escape through the orifice (2) in the cap and push the flexible bubble (4) of the valve (3) so as to escape ultimately through the ventilation holes of the latter. In order to prevent any risk of explosion, the cap comes free from the teat-holder in the event of valve failure.

The cap (1) according to the invention can advantageously comprise means for releasing the cap from the teat-holder (9).

Once sterilised, the pacifier is ready for use. It is watertight, airtight and sterile. After use, it can be washed and sterilised again for the next use.

The invention also relates to a sterilisation method for reusable teats or feeding bottles according to the invention, comprising the following steps:

Inserting a reusable pacifier or feeding bottle according to the invention comprising sterilising means in a microwave oven.

Activating said microwave at a power level such that the steam formed from the sterilising means can escape through the cap orifice (2).

The sterilising means can advantageously be water.

1. A cap for reusable pacifiers and feeding bottles, allowing them to be sterilised in a microwave oven, comprising:
means for attaching the cap to reusable pacifiers and feeding bottles; and
means for allowing the steam to pass through an orifice, in sterilization mode and for hermetically resealing the orifice after sterilization.

2. The cap according to claim 1, wherein the means for allowing the passage of steam is a pressure valve.

3. The cap according to claim 2, further comprising a pressure valve with an inverted flexible bubble, which can be pushed back by the steam pressure so as to allow the evacuation of steam through the orifice during sterilization and then to hermetically reseal the orifice in order to preserve its sterility.

4. A reusable pacifier or feeding bottle comprising at least one cap according to claim 1.

5. The reusable pacifier or feeding bottle according to claim 4, wherein said reusable pacifier or feeding bottle is watertight and airtight after sterilization.
